(19) United States
(12) Patent Application Publication
(10) Pub. No.: US 2010/0118983 A1
(43) Pub. Date: May 13, 2010

(54) COMMUNICATION OVER A DC POWER LINE

(76) Inventors: Marc Weber, Abingdon (GB); Enrico Giulio Villani, Oxford (GB)

Correspondence Address: BIRCH STEWART KOLASCH & BIRCH, PO BOX 747, FALLS CHURCH, VA, 22040-0747, US

(21) Appl. No.: 12/594,458

(22) PCT Filed: Apr. 2, 2008
(86) PCT No.: PCT/GB08/01154

§ 371 Date: Oct. 2, 2009

(30) Foreign Application Priority Data
Apr. 2, 2007 (GB) 0706422.3

(51) Int. Cl. H04L 25/00; H04B 3/54

(52) U.S. Cl. 375/257; 307/1

(57) ABSTRACT

A combined power and communication system, a transmitter, a receiver, and a method of communicating data over a power line are provided. A power supply is arranged to supply an output current to a power line and comprises a current source. The current source is arranged to supply a DC component to the output current and the power supply is further arranged to mod the output current according to a data signal. A load interface is arranged to receive a load at load terminals, to provide DC power from the power line to the load terminals, and to demodulate the current received from the power line to receive the data signal.

### TECHNICAL FIELD

This invention relates to bi-directional data communication over an electrical connection carrying DC power. This may be applicable, for example, in arrays of sensors or transducers.

### BACKGROUND TO THE INVENTION

In many applications, it is important that one or more devices both be supplied with power and be provided with a means for communicating data with other devices. Although these power and data connections may be provided separately, it is often desirable that both power and data are provided over the same connection. This is particularly advantageous in situations where the size, weight or quality of cabling is restricted or where it is desirable to limit the number of connections.

Technologies for data communication over a connection providing AC power are well known. There also exist technologies for providing communication over a DC power connection. These may be attractive when using multiple DC-powered transducers, especially when these are spread over a wide area.

For example, U.S. Pat. No. 5,727,025 relates to data communication by superimposing a carrier signal modulated by a data signal onto a DC power signal. However, this document does not specify how the DC power signal is modulated or how the signals of more than one transmitter may be multiplexed over the DC power line.

Many systems also require communication between a central server, which provides power, and multiple clients. One such application may be communication from a central server to a number of output devices, for example sending video signals to multiple display screens on an aircraft. Another application may be a sensor array, for instance in a large scientific instrument, where multiple devices communicate data to a central server. Bi-directional communication is also advantageous.

In these and other situations, it is desirable to reduce thermal losses over the DC power line to increase power transfer, which includes the communication signal, from power supply to load.

### SUMMARY OF THE INVENTION

Against this background, the present invention provides a combined power and communication system. The system comprises a power supply and a load interface. The power supply is arranged to supply an output current to a power line and comprises a current source. The current source is arranged to supply a DC component to the output current. The power supply is then further arranged to modulate the output current according to a data signal.

The load interface is arranged to receive a load at load terminals. The load interface is also arranged to provide DC power from the power line to the load terminals and to demodulate the current received from the power line to receive the data signal.

The present invention thereby advantageously allows communication between the power supply and a load interface over a DC power line, where the power supply also provides power to the load. The use of a current source in the power supply, that may be regulated, means that thermal losses over the power connection, which are related to the current over the line, may be minimised. This makes the system more robust, and more suitable for applications where AC power connections cannot be provided and long power cables are needed, for example in an underground particle detector. The load interface is also able to demodulate the current to receive signal whether the current consumed by the load is constant or whether it varies over time.

Preferably, the current source is further arranged to supply a fixed DC component to the output current. This DC component may be equal to the maximum current consumed by a load in the system. Alternatively or additionally the current source provides a variable current component. The variable component may advantageously be adjusted so as to modulate the output current according to the data signal, particularly when the variable component is combined with a fixed component.

Alternatively, the power supply may comprise a current sink connected to the current source, the current sink being arranged to adjust the output current so as to modulate the output current. The power supply may alternatively modulate the current output in other ways. The modulation is preferably digital, although analogue modulation is alternatively possible. Pulse modulation is preferably used.

In the preferred embodiment, the load interface includes a shunt regulator, which regulates the voltage across the load terminals to be substantially constant. The shunt regulator may be arranged across the load terminals and preferably operates by drawing current received from the power line that is not drawn through the load terminals. The shunt regulator may advantageously sense the voltage across the load and draw a current from the power line, away from the load, such that the voltage across the load is maintained substantially constant.

The shunt regulator may also sense variations in the current on the power line. These variations can be provided to a demodulator, which demodulates the sensed variations in the current, to thereby receive the data signal. The demodulator may be implemented using a microprocessor or using dedicated hardware.

Preferably, the load interface is further arranged to modulate the voltage across the load interface according to a second data signal. Advantageously, the power supply is further arranged to demodulate the voltage across the power supply to receive the second data signal.

The use of current modulating to transmit from the power supply to the load interface and voltage modulation to transmit from the load interface to the power supply allows simultaneous bi-directional communication over the power line. The load interface is preferably powered by power received from the power line. The voltage modulation is preferably digital, although analogue modulation may alternatively be used.

In the preferred embodiment, a second load interface is connected in series with the first load interface. The second load interface demodulates the current received from the DC power connection, and modulates the voltage across the DC power line. The second load interface may supply substantially DC power to a load. This load may be a second load, or it may be the same load powered by the first load interface. If the load is a second load, it may have identical parameters, including identical current consumption to the first load. Alternatively, the parameters, including current consumption may be different.

The use of a substantially constant current source advantageously means that the current supplied to each load is fixed. Moreover, both first and second loads may modulate the voltage across the DC power connection independently from one another.

As a result, no separate data transmission lines are needed, all loads receive the same current signal as the loads cannot sink current, the maximum signal speed can be high, the system is inherently robust as power cables do not easily break and the power consumption of the signal transfer tends to be low. Moreover, the voltage modulation by the load is a differential transmission signal and thus immunity to noise is increased. Hence, the present invention is also applicable to video systems in transport systems, automotive or nautical electrical installations, oil-fields and mines.

The present invention may also be found in a combined power and communication system comprising: a power supply, arranged to supply an output current to a power line, the output current comprising a DC component; and a load interface, arranged to receive a load at load terminals, to provide DC power from the power line to the load terminals, and to modulate the voltage on the power line across the load interface according to a data signal; wherein the power supply is further arranged to demodulate the voltage across the power supply, to receive the data signal.

### BRIEF DESCRIPTION OF THE DRAWINGS

The invention may be put into practice in various ways, one of which will now be described by way of example only and with reference to the accompanying drawings in which:

FIG. 1 shows a block diagram of a system according to the present invention, having a power supply, a load interface and a load.

FIG. 2 shows a schematic diagram illustrating an embodiment of the system of FIG. 1.

FIG. 3 shows a block diagram of the system of FIG. 1 with multiple load interfaces and multiple loads.

FIG. 4 shows a more detailed schematic diagram of the load interface embodiment shown in FIG. 2.

### SPECIFIC DESCRIPTION OF A PREFERRED EMBODIMENT

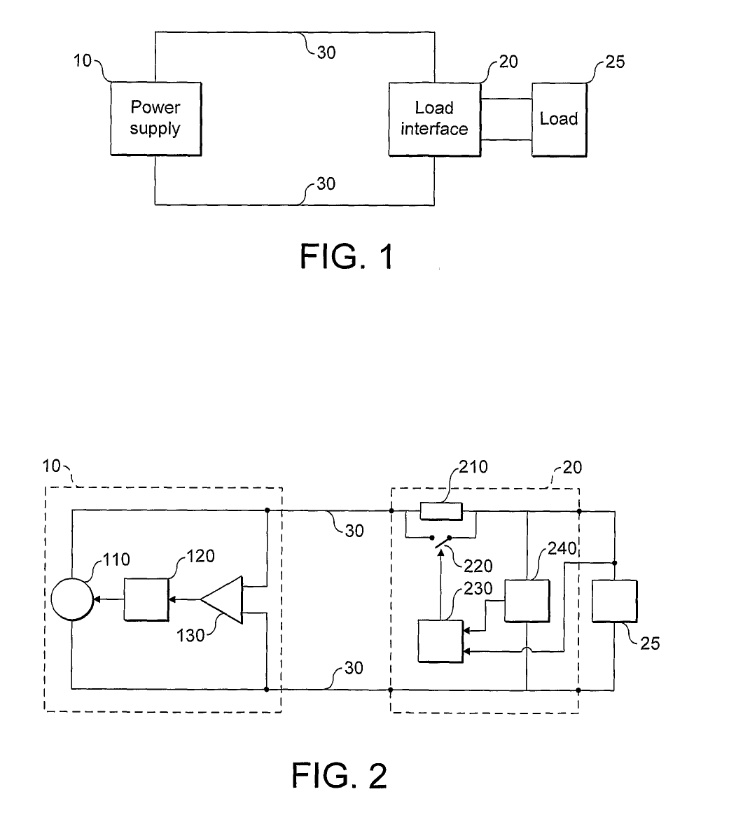

Referring first to FIG. 1, there is shown a block diagram of a system according to the present invention. The system comprises power supply 10, which supplies power to load interface 20, through DC power connection 30. Load interface 20 is connected to load 25.

Power supply 10 regulates the current that flows through DC power connection 30. The current comprises a non-zero constant component, such that DC power flows through connection 30. However, power supply 10 also causes the regulated current that is supplied to connection 30 to have a varying component. This variation is made on the basis of a data signal that is intended for transmission to load interface 20. This variation thereby causes the current to be modulated.

Load interface 20 draws power from the current that flows through connection 30. Load interface 20 supplies DC power to load 25. It also senses the varying component of the current, demodulating the current to obtain the data signal transmitted by power supply 10.

Load interface 20 also causes the voltage across itself to be varied on the basis of a second data signal, thereby modulating the voltage across the load interface. The power supply senses these voltage variations and demodulates the sensed voltage to receive the second data signal.

Referring next to FIG. 2, there is shown a schematic diagram illustrating an embodiment of the systems of FIG. 1. Power supply 10 comprises current source 110 which provides a substantially DC current, microprocessor 120 and differential amplifier 130. Load interface 20 comprises impedance 210, impedance switch 220, microprocessor 230 and shunt regulator 240. Load interface 20 is connected to load 25.

In the power supply 10, microprocessor 120 controls current source 110. The current source 110 establishes the current that flows through connection 30 and thereby load interface 20. A current sink is provided close to, or as part of current source 110 to superimpose a variable digital or analogue signal onto the DC current supplied by the current source on the basis of a data signal. Microprocessor 120 thereby causes current pulses to be superimposed on top of the DC current supplied by current source 110. The current pulses are representative of the data signal.

Some of the current flowing through load interface 20, flows through shunt regulator 240. This acts as a local power supply to load 25, ensuring that the voltage across the load 25 is substantially constant. Shunt regulator 240 acts as an adjustable resistor in parallel with the load 25. The shunt regulator draws current from the power line such that the voltage across the shunt regulator is maintained at a fixed value. If the current supplied by power supply 10 exceeds the current consumption of the load, the excess current flows through the shunt regulator 240.

By having shunt regulator 240 close to load 25, the power supply rejection ratio is inherently high. Hence, the system is less sensitive to voltage or current fluctuations on the power line 30. This thereby mitigates the effects of noise or unwanted signal pick-up on the power line. Moreover, the use of shunt regulator 240 means that the effect of load 25 on the electrical model of load interface 20 as seen by power supply 10, is much reduced.

The excess current flowing through shunt regulator 240 comprises modulation added to the current at the power supply. This modulated signal can be passed from the shunt regulator 240 to a microprocessor 230 for demodulation and decoding.

Microprocessor 230 also controls impedance switch 220. By switching impedance switch 220, impedance 210 is switched into and out of the circuit. This causes the overall impedance of the load interface 20 to vary. When the impedance of load interface 20 varies, the voltage drop across load interface 20 varies accordingly. Microprocessor 230 thereby causes voltage pulses to be superimposed on the substantially constant voltage across load interface 20. The voltage pulses are representative of a data signal.

This variation in voltage may be sensed by differential amplifier 130 in power supply 10. This results in voltage pulses appearing across the input to the differential amplifier 130. These pulse are thereby passed to microprocessor 120 for demodulation and decoding of the data signal transmitted by load interface 20.

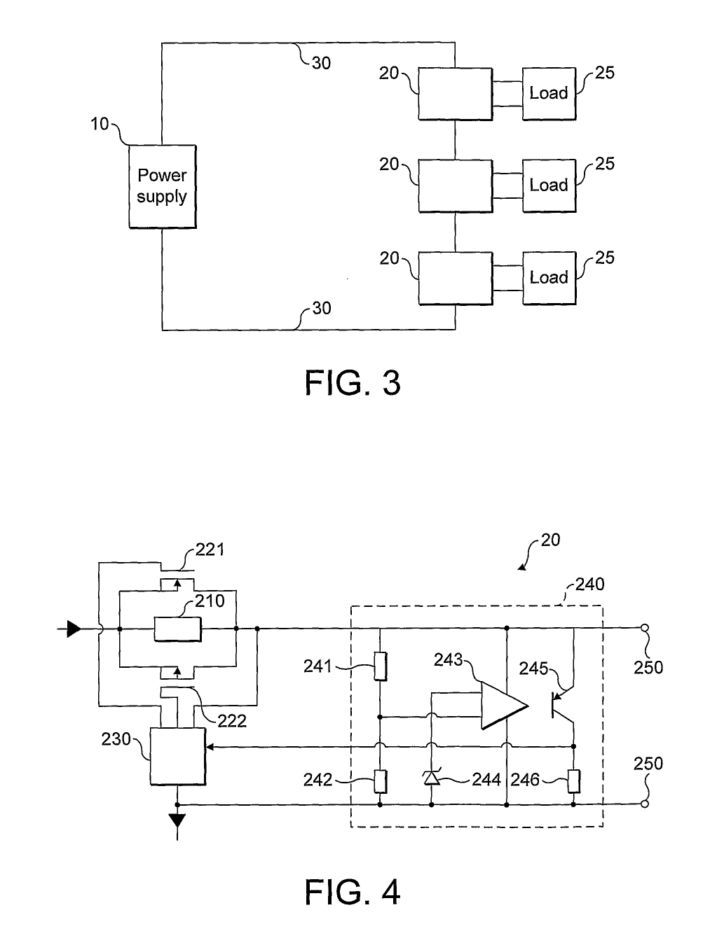

Referring now to FIG. 3, there is shown a block diagram based on the system of FIG. 1, but having multiple load interfaces. The multiple load interfaces are connected in series. Each load interface is connected to a load 25, although these loads need not be identical between load interfaces.

The concept of powering loads in series with a single power supply is known as serial powering. This concept is advantageous when the loads require voltage regulation and are expected to draw similar currents. Then, the choice of current provided by the source is dictated by efficiency reasons, to minimise thermal losses in the power lines. In parallel powering using a constant voltage source, the current drawn from the power supply is equal to the sum of all the currents drawn by each load and, where appropriate, load interface. This leads to significant thermal losses in the power connection. In contrast, the current drawn from the power supply when serial powering is used need only be as large as the maximum individual current drawn over all of the loads in the system. Hence, thermal losses are reduced. This concept is particularly applicable where the impedance of the power connection may be large, for example where long cables are required. Such applications include detector instrumentation, although it may be used in other applications.

In this embodiment, power supply 10 modulates the current carried by connection 30 to each of the loads in series. Each load is thereby able to receive the data signal transmitted by power supply 10. Moreover, each load is able to modulate the voltage across itself in order to transmit a data signal back to power supply 10.

Referring to FIG. 4, there is shown a more detailed schematic diagram of the load interface embodiment shown in FIG. 2. Current from the power line is drawn through impedance 210. An impedance switch is provided by pass transistors 221 and 222, which are controlled by microprocessor 230. The current then flows out into shunt regulator 240, which is connected in parallel with load terminals 250, to which a load may be connected.

The pass transistors 221 and 222 are controlled by microprocessor 230 to thereby vary the impedance of the load interface 20 as seen by the power supply. In this way, a digital signal can be applied to pass transistors 221 and 222, which causes the impedance 210 to be switched in and out according to this digital signal. Hence, the voltage across the load interface 20 varies according to this digital signal.

Shunt regulator 240 comprises a potential divider comprising resistors 241 and 242, operational amplifier 243, band gap reference 244, power device 245 and low impedance current sense 246.

Power device 245 is controlled by comparator 243 and acts a sink for excess current received from the power supply 10, that is not consumed by load 25. In so doing, the voltage across and current consumed by load 25 remain substantially constant. The excess current drawn by power device 243 is sensed by low impedance current sense 246. This low impedance current sense may be a hall probe or a resistor. The excess current causes a proportional voltage drop across the current sense, which is measured by microprocessor 230. The current pulses sent by power supply 10 are thereby translated into voltage pulses detected by load interface 20.

Over-current protection may advantageously be provided for the shunt regulator to mitigate any problems when the load is disconnected or stops drawing significant current.

It is observed that power consumption of the system from transmission from power supply 10 to load interface 20 depends on the DC connection resistance, the method used to sense the current fluctuations (e.g. the value of the low impedance current sense) and the amplitude of the current variation. Moreover, the bandwidth for transmission is determined by the bandwidth of the shunt regulator and can be high.

Whilst a specific embodiment has been described herein, the skilled person may contemplate various modifications and substitutions. For example, the skilled person will readily appreciate that there are alternative methods for varying the voltage drop across load interface 20, such as different methods for varying the impedance of load interface 20.

Although the power consuming loads of the preferred embodiment are powered by a fixed DC current, the skilled person will understand that a power consuming load need not draw a fixed current. Alternatively, a power consuming load may draw a variable current. In such a case, the excess current not used by the power consuming load may vary over time. The skilled person will appreciate that there are processing or filtering techniques known in the art for separated such variation from the modulation transmitted by the power supply, for instance pattern recognition. Optionally, the voltage across the load may be varied.

Although the embodiment described herein uses microprocessors to firstly, control the components of the system, secondly to cause modulation and thirdly, to provide demodulation as necessary, the skilled person will appreciate that digital logic circuitry may be substituted for one or more of these functions. Different functions may be implemented in different forms of hardware or software. Alternatively analogue circuitry may be used for one or more of these functions.

The skilled person will also recognise that the signal received at the power supply, may be used for communicating or controlling either further circuitry or the power supply itself. For example the present invention may be used in a system for providing power and audio to seats on an aircraft. In such a example, the user at each seat may indicate a preference for audio and the signal transmitted by each load interface corresponds with this preference. Then the signal received at the power supply may be used to control an audio device, for example a CD player.

Additionally or alternatively, the signal received at the load interface may be passed to the load or it may be passed to a further device. For example, in the case where the load is a sensor, the signal received at the load interface may change a parameter of the sensor instead of or as well as a parameter of the subject being measured by the sensor.

The skilled person will appreciate that the shunt regulator described in the above embodiment is implemented in an integrated circuit, but that it may alternatively be implemented using discrete components. An operational amplifier circuit may be replaced by another form of comparator circuit and a zener diode may substitute a band gap reference.

It will also be readily understood that there are alternative ways to sense the current at the load or to vary the input impedance. These include, for example, Hall probing, Giant Magneto Resistance effect and electronic inductors.

1. A combined power and communication system comprising:
a power supply, arranged to supply an output current to a power line and comprising a current source, the current source being arranged to supply a DC component to the output current, the power supply being further arranged to modulate the output current according to a data signal; and
a load interface, arranged to receive a load at load terminals, to provide DC power from the power line to the load terminals, and to demodulate the current received from the power line to receive the data signal.

2. The system of claim 1, wherein the load interface is further arranged to modulate the voltage on the power line across the load interface according to a second data signal.

3. The system of claim 2 wherein the load interface is further arranged to vary its impedance on the power line, so as to modulate the voltage across the load interface.

4. The system of claim 2, wherein the power supply is further arranged to demodulate the voltage on the power line across the power supply to receive the second data signal.

5. A combined power and communication system comprising:
a power supply, arranged to supply an output current to a power line, the output current comprising a DC component; and
a load interface, arranged to receive a load at load terminals, to provide DC power from the power line to the load terminals, and to modulate the voltage on the power line across the load interface according to a data signal;
wherein the power supply is further arranged to demodulate the voltage across the power supply, to receive the data signal.

6. The system of claim 1, wherein the current source is further arranged to supply a fixed DC component.

7. The system of claim 1, wherein the current source is further arranged to provide a variable component.

8. The system of claim 7, wherein the current source is further arranged to adjust the variable component of the output current according to the data signal so as to modulate the output current.

9. The system of claim 1, wherein the power supply further comprises a current sink connected to the current source, the current sink being arranged to adjust the output current so as to modulate the output current.

10. The system of claim 1, wherein the load interface comprises a shunt regulator, the shunt regulator being arranged to regulate the voltage across the load terminals to be substantially constant.

11. The system of claim 10, wherein the shunt regulator is arranged across the load terminals and is configured to draw current received from the power line that is not drawn through the load terminals.

12. The system of claim 10, wherein the shunt regulator is configured to sense variations in the current on the power line.

13. The system of claim 12, wherein the load interface further comprises a demodulator, configured to demodulate the sensed variations in the current and to thereby receive the data signal.

14. The system of claim 1, wherein the load interface is a first load interface and further comprising:
a second load interface, connected in series with the first load interface on the power line and arranged to receive a load and to provide DC current from the power line to the load.

15. The system of claim 14, wherein the second load interface is further arranged to demodulate the current received from the power line to receive the data signal.

16. The system of claim 14, wherein the second load interface is further arranged to modulate the voltage on the power line across the second load interface according to a third data signal.

17. The system of claim 16, wherein the power supply is further arranged to demodulate the voltage on the power line across the power supply to receive the third data signal.

18. The system of claim 1, wherein the load interface is arranged to be powered by power received from the power line.

19. The system of claim 18, wherein the load interface is a first load interface and further comprising:
a second load interface, connected in series with the first load interface on the power line and arranged to receive a load at load terminals and to modulate the voltage on the power line across the second load interface according to a second data signal.

20. A method of communicating data over a power line between a power supply and a load interface connected to a load, the power supply having a current output connected to the power line and comprising a current source, the method comprising:
providing a DC component from the current source to the current output;
modulating the current output according to a data signal;
providing DC current from the power line via the load interface to the load; and
demodulating the current received from the power line at the load interface to receive the data signal.

21. The method of claim 20, further comprising: modulating the voltage on the power line across the load interface according to a second data signal.

22. The method of claim 21, wherein the step of modulating the voltage on the power line across the load interface comprises varying the impedance of the load interface on the power line.

23. The method of claim 21, further comprising:
demodulating the modulated voltage across the power supply to receive the second data signal.

24. The method of claim 20, wherein the step of modulating the current comprises adjusting a current sink connected to the current source according to the data signal.

25. A method of communicating data over a power line between a power supply and a load interface, the power supply having a current output comprising a DC component connected to the power line, the method comprising:
modulating the voltage on the power line across the load interface according to a data signal; and
demodulating the modulated voltage on the power line across the power supply to receive the data signal.

26. The method of claim 20, wherein the DC component is fixed in magnitude.

27. The method of claim 26, further comprising:
providing a variable component from the current source to the current output.

28. The method of claim 27, wherein the step of modulating the current output comprises adjusting the variable component according to the data signal.

29. A power supply data transmitter having an output current, the transmitter comprising: a current source, arranged to supply a DC component to the output current for powering an associated load; and a modulator, arranged to modulate the output current according to a data signal.

30. A receiver, arranged to be connected to a power line carrying a DC current modulated according to a data signal, to receive a load at load terminals and to provide DC power from the power line to the load terminals, the receiver comprising a demodulator, arranged to demodulate the current received from the power line to receive a data signal from an associated power supply data transmitter.

31. A transmitter, arranged to receive power from a power line connected to an associated power supply providing DC current, to receive a load at load terminals and to provide DC power to the load terminals, the transmitter comprising a modulator, arranged to modulate the voltage on the power line across the transmitter according to a data signal.

32. A power supply receiver having output terminals, the receiver comprising: a current source, arranged to supply a DC current component to the output terminals for powering an associated transmitter; and a demodulator, arranged to demodulate the voltage across the output terminals to receive a data signal.

33. The system of claim 5, wherein the current source is further arranged to supply a fixed DC component.

34. The system of claim 5, wherein the current source is further arranged to provide a variable component.

35. The system of claim 5, wherein the power supply further comprises a current sink connected to the current source, the current sink being arranged to adjust the output current so as to modulate the output current.

36. The system of claim 5, wherein the load interface comprises a shunt regulator, the shunt regulator being arranged to regulate the voltage across the load terminals to be substantially constant.

37. The system of claim 36, wherein the shunt regulator is arranged across the load terminals and is configured to draw current received from the power line that is not drawn through the load terminals.

38. The system of claim 36, wherein the shunt regulator is configured to sense variations in the current on the power line.

39. The system of claim 5, wherein the load interface is arranged to be powered by power received from the power line.

40. The method of claim 25, wherein the DC component is fixed in magnitude.

41. The method of claim 40, further comprising:
providing a variable component from the current source to the current output.
